(19) United States
(12) Patent Application Publication
(10) Pub. No.: US 2008/0045154 A1
(43) Pub. Date: Feb. 21, 2008

(54) METHOD AND APPARATUS FOR BEAM-FORMED MULTIPLE INPUT MULTIPLE OUTPUT WIRELESS COMMUNICATIONS

(76) Inventor: Shiquan WU, Ottawa (CA)

Correspondence Address: McGUINNESS & MANARAS LLP, 125 NAGOG PARK, ACTON, MA, 01720, US

(21) Appl. No.: 11/465,537

(22) Filed: Aug. 18, 2006

(51) Int. Cl. H04B 1/10; H04B 7/00; H04B 1/00; H04B 15/00

(52) U.S. Cl. 455/65; 455/506

(57) ABSTRACT

There is provided a system and method of transmitting wireless data. The data signal has a multipath effected upon it and the effected multipath is used to decode the received signal. This is achieved by either passing the signal through a multipath filter prior to transmission or by producing a plurality of reflections of the transmitted signal. In the receiving end, the multipath selector will choose a preferred multipath profile and then form the data vectors for further processing. Systems for multiple input multiple output (MIMO) are thereby possible with fewer receiving antennas than transmitting antennas. Also orthogonal frequency division multiples (OFDM) systems are possible in multipath environments. Combining of beam-forming and MIMO and OFDM systems is also enabled.

### FIELD OF THE INVENTION

The present invention relates to methods and apparatuses for beam-formed multiple input multiple output wireless communications.

### BACKGROUND OF THE INVENTION

Beam-forming and MIMO (multiple-inputs multiple outputs) are two major technologies that can significantly enhance wireless air interface performance in terms of coverage and capacity.

Beam-forming uses multiple antennas in a BTS (base-station transceiver system), usually implemented as a phase antenna array and requires the inter-element distance is not more than half of the wavelength. With proper weighting on the inputs to antennas, the radiation pattern can be narrowed to a desired beam pattern so that the coverage can be enhanced and interferences can be mitigated. For upward transmission, i.e. BTS receives and terminal transmits, with similar concept, the receiving beam pattern can be so designed so that only the desired terminal signal is enhanced while all others are diminished or attenuated. In theory, the capacity increases as a logarithmic function of the number of transmitter antennas.

A MIMO system uses multiple antennas in both BTS and terminal ends. A fundamental assumption for this technology is that the number of receiving antennas, noted as N, must be not less than the number of transmitting antennas, noted as M. Although BTS antennas can be arbitrarily displaced (an advantage compared to beam-forming), the terminal design is troublesome in terms of space, processing power, packing and cost.

In terms of real performance, beam-forming does not work well in a multi-path rich environment and in mobility applications. By contrast to beam-forming technology, MIMO systems do not work well in LOS (line of sight) 10 and keyhole environments 12 as shown in FIG. 1.

Hence these two technologies contradict each other in practice, as it is very difficult to control environment changes.

As shown in FIG. 2, know wireless communication systems usually include three major components, an antenna system 14, a radio frequency (RF) system 16 and a modem 18. The transmitted signal is usually formatted in a slot or frame basis. As an example, FIG. 3 illustrates the WiMax/16e TDD (time division duplex) frame structure 20 (refer to [1]). Each frame consists of 5 ms, which is divided into 2 time intervals, one for downward (BTS to terminal) transmission and the other for upward transmission (terminal to BTS). The first OFDM symbol is always a preamble that is used for time synchronization, frequency error correction and initial channel estimation etc.

A transmitting antenna radiates stronger electromagnetic (EM) waves in some directions than others. When EM waves are measured from a point far from the transmitting antenna, the result is a sum of all radiations from all of the parts of antenna. When the result is plotted it is called a beam pattern. The receiving antenna beam pattern is always the same as the transmitting beam pattern. Each small part of antenna radiates an EM wave with a different amplitude and phase. When each of these waves reaches the receiver, these waves are either constructively combined or destructively combined. Beam-forming is just exploiting this EM wave property by causing each element to radiate a different wave with a controllable amplitude and phase so that they are constructively combined together to form a stronger wave before the waves start to travel to a greater distance.

FIG. 4 illustrates the key elements of a beam-forming antenna system, a modem 22, a plurality of weighting factors 24, a plurality of RF systems and an antenna array 28 for forming a beam to a remote terminal 30. Weighting factors w₁, w₂, . . . , w_{M} are design parameters that can be either fixed or dynamically changed according to the terminal 30 being used.

As shown in FIG. 5 multiple input multiple output system (MIMO) also uses multiple antennas in both transmit and receive ends, 32 and 34, respectively. Each end of the MIMO system includes a modem 36 and a plurality of antennas 38. The main difference between a beam-forming system and a MIMO system is that each individual MIMO antenna transmits an independent data stream. Consequently, the capacity is linearly increased. Due to the fact that all of the signals occupy the same radio resource (i.e. spectrum or time slot), the receive end must have a way to distinguish each individual signal, then decode all of them.

In FIG. 5, Sₘ denotes the signal will be transmitted from antenna m (m=1, 2, . . . , M) and Yₙ denotes the signal received by receiver antenna n (n=1, 2, . . . , N); hₘₙ denotes the fading parameter between transmitter antenna m and receiver antenna n. Mathematically, the transmitter and receiver of FIG. 5 can be modeled as:

$$[ \begin{matrix}{y}_{1} \\ {y}_{2} \\ ⋮ \\ {y}_{N}\end{matrix} ] = [ \begin{matrix}{h}_{11} & {h}_{21} & ⋯ & {h}_{M 1} \\ {h}_{21} & {h}_{22} & ⋯ & {h}_{M 2} \\ ⋯ & ⋯ & ⋯ & ⋯ \\ {h}_{N 1} & {h}_{N 2} & ⋯ & {h}_{NM}\end{matrix} ] [ \begin{matrix}{s}_{1} \\ {s}_{2} \\ ⋮ \\ {s}_{M}\end{matrix} ] + [ \begin{matrix}{N}_{1} \\ {N}_{2} \\ ⋮ \\ {N}_{N}\end{matrix} ] \qquad ( 1 )$$

The matrix H is dependent upon environment and is the key for system capacity. The MIMO decoder needs a full rank matrix H so that the above linear equation can be resolved to derive the M unknowns s₁, s₂, . . . , s_{M}.

The modem is used to process a base-band signal either for transmission or reception. Different products or standards have quite different flow boxes and designs. However, they are more or less generically the same. In the following figures we only provide simplified diagrams to illustrate how OFDM works with one or multiple (two for example) antennas.

Referring to FIG. 6, there is illustrated a transmitter 40 with one antenna 42. Information bits are fed into a forward error correction (FEC) encoder 44 that encodes the bits with some redundancy built in. The coded bits are than mapped 46 to constellation symbols. After a serial to parallel conversion 48, an inverse fast Fourier transform (IFFT) 50 with appropriate size (say 64 for WiFi, 1024 for WiMax) is applied. The output of IFFT 50 is then converted back to serial format 52 and a cyclic prefix (CP) is usually appended in front 54 so that the linear convolution can be automatically translated into a cyclic convolution after removing it in the receiving end. A windowing filter 56 is applied for the data blocks to control the adjacent emission masks to meet the specification requirement. A digital to analogue converter (DAC) 58 up converts the signal to analog format, which is amplified (not shown) and radiated from the antenna 42.

Referring to FIG. 7, there is illustrated a receiver 60 with one antenna 62. In the receiving end, the received signal is down converted and digitized by an analogue to digital converter (ADC) 64. A matching filter 66 can be applied to maximize the signal gain. The digitized data is fragmented accordingly and the portion of CP is removed 68. The fragmented data is then converted to a format 70 suitable for fast Fourier transform (FFT) 72. After FFT 72, the multipath channel is estimated 74 via known sequences (such as pilots, training sequence, preamble etc) and a maximum likelihood detection is usually applied to map the received data back to constellation symbol level 76 either in hard bit or soft bits, which are then input to a FEC decoder 78.

Referring to FIG. 8, there is illustrated a typical OFDM transmitter 80 with two antennas 82. In the OFDM transmitter 80, a raw bits sequence/block is fed into a forward error correction (FEC) encoder 84, the encoded bits are mapped into QAM constellation symbols 86, a serial to parallel block 88 splits the constellation sequence into multiple (e.g. two antennas) sub-sequences that are fragmented to fit the designated IFFT operations 90a and 90b. After IFFT operation, the data block is converted to serial sequence again 92a and 92b, a cyclic prefix (CP) 94a and 94b is attached, the whole sequence goes through a shaping or a windowing filter 96a and 96b and then is up-converted to an analog signal for transmission 98a and 98b.

A typical 2×2 OFDM MIMO receiver as shown in FIG. 9, reverses the transmitter process of FIG. 8. and transforms the data back to bits.

Methods and apparatuses for beam-formed multiple input multiple output wireless are disclosed to obviate or mitigate at least some of the aforementioned disadvantages.

### SUMMARY OF THE INVENTION

An object of the present invention is to provide improved methods and apparatuses for beam-formed multiple input multiple output wireless.

Accordingly the present invention unifies OFDM and MIMO technologies while retaining their benefits while reducing their shortcomings.

In accordance with an aspect of the present invention there is provided a wireless data communications system comprising means for effecting multipath onto a signal means for receiving the signal and means for decoding the signal in dependence upon the multipath effected.

In accordance with another aspect of the present invention there is provided method of a wireless data communications comprising the steps of effecting multipath onto a signal, receiving the signal and decoding the signal in dependence upon the multipath effected.

### BRIEF DESCRIPTION OF THE DRAWINGS

The present invention will be further understood from the following detailed description with reference to the drawings in which:

FIG. 1 illustrates environments in which multiple input multiple output (MIMO) system have difficulty operating effectively;

FIG. 2 illustrates typical wireless communications equipment components;

FIG. 3 illustrates an exemplary frame structure;

FIG. 4 illustrates a known beam-forming system;

FIG. 5 illustrates a known MIMO system;

FIG. 6 illustrates a typical transmitter with one antenna;

FIG. 7 illustrates a typical receiver with one antenna;

FIG. 8 illustrates a typical OFDM transmitter with two antennas;

FIG. 9 illustrates a typical OFDM receiver with two antennas;

FIG. 10 illustrates a OFDM receiver in accordance with a first embodiment of the present invention;

FIG. 11 illustrates a OFDM transmitter with two antennas in accordance with a second embodiment of the present invention;

FIG. 12 illustrates a OFDM transmitter with two antennas in accordance with a third embodiment

FIG. 13 illustrates a OFDM MIMO receiver in accordance with a fourth embodiment of the present invention of the present invention;

FIG. 14 illustrates beam-forming MIMO configurations in accordance with a sixth embodiment of the present invention;

FIG. 15 illustrates a beam-formed MIMO transmitter with built in multipath in accordance with a seventh embodiment of the present invention;

FIG. 16 illustrates passive reflectors used to introduce multipath in accordance with a eight embodiment of the present invention;

FIG. 17 illustrates a 2×2 MIMO receiver in accordance with a tenth embodiment of the present invention.

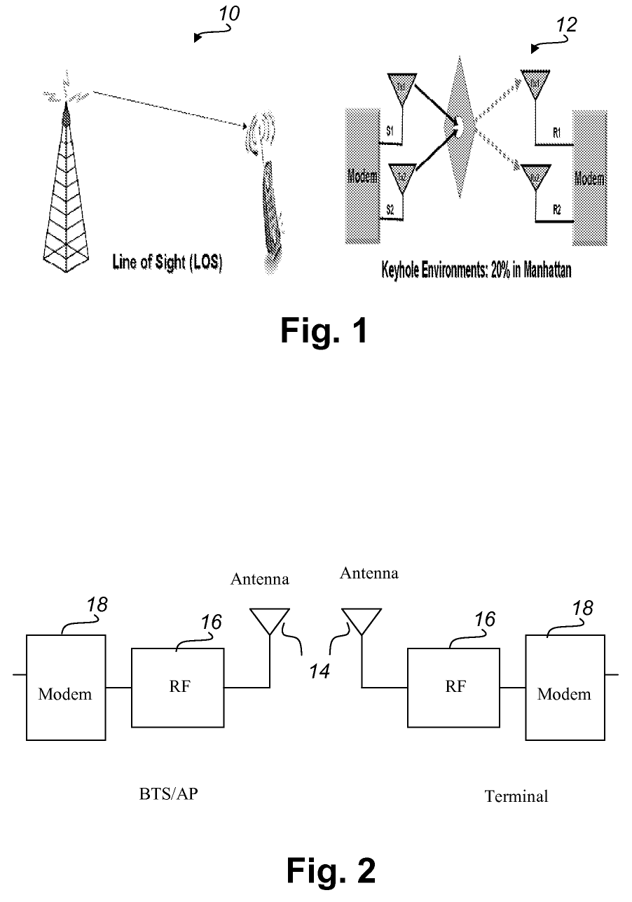

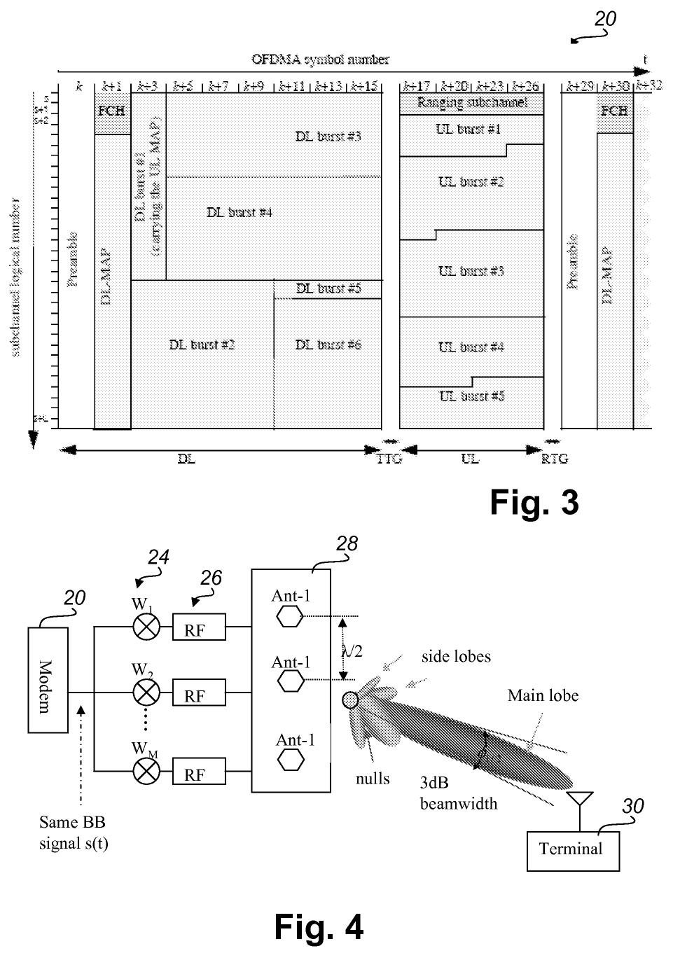

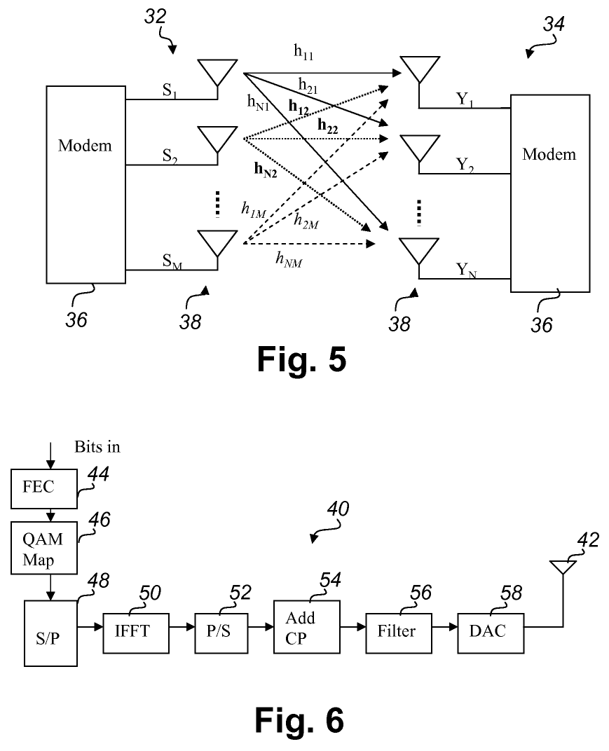

### DETAILED DESCRIPTION OF THE PREFERRED EMBODIMENT

Referring to FIG. 10, there is illustrated a OFDM receiver in accordance with a first embodiment of the present invention. The OFDM receiver 102 includes an antenna 103, an ADC 104, a filter 106, a remove CP 108, a channel equalizer and a decoder 110. A maximum likelihood detection is applied to map the received data back to constellation symbol level 112 and then input to a FEC decoder 114.

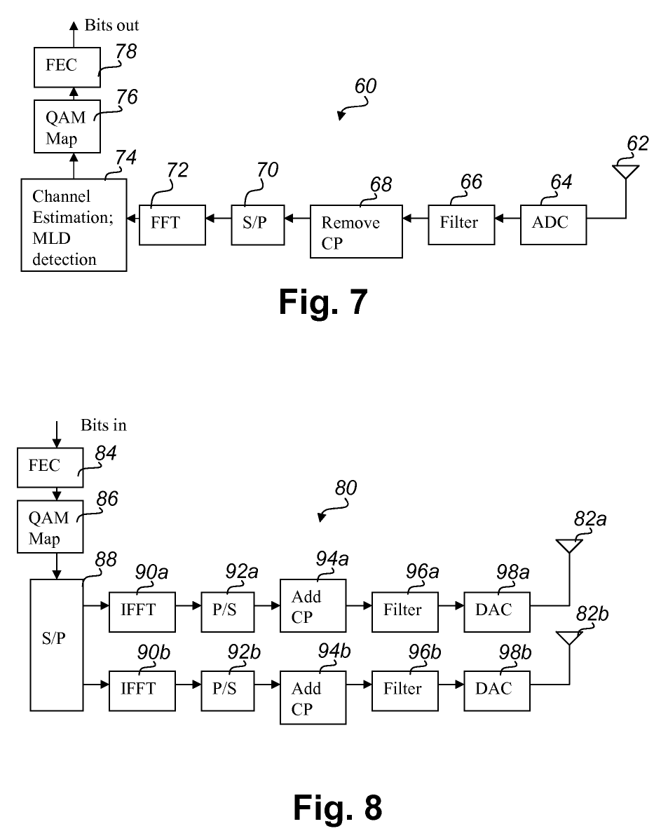

A traditional OFDM demodulator always needs an FFT operation (as shown in FIG. 7). In the embodiment of FIG. 10, we illustrate a time domain de-modulator that does not need a FFT operation on the data portion. For some scenarios, such as fixed deployment where channel does not change very quickly, this can save a lot of computation.

Let N denote the FFT length, typically N=64, 128, 256, 512, 1024, 2048, but in theory can be any positive integer number; s(0), s(1), . . . , s(N−1) be the constellation symbol sequence that are transmitted in one OFDM symbol. According to Eq. (1) antenna transmission diagram (FIG. 6), the transmitted time domain signal is the IFFT output of the constellation symbol sequence, i.e.

$$y ( k ) = \frac{1}{\sqrt{N}} {\sum }_{l = 0}^{N - 1} {s ( l ) [ exp ( \frac{2 π}{N} j ) ]}^{lk} \qquad ( 2 )$$

for k=0, 1, . . . , N−1

### We denote the multipath channel as ch(t) and the Nyquist sampling interval is T, the received signal after the cyclic extension removal can be expressed as

{r(0),r(1), . . . r(N−1)}={y(0),y(1), . . . ,y(N−1)}⊕{ch(0),ch(1), . . . , ch(N−1)}

### Where the convolution is a cyclic convolution and therefore r(k) can be expressed as

$$r ( n ) = {\sum }_{k = 0}^{N - 1} y ( k ) c h ( n - k ) \qquad ( 3 )$$

form=0, 1, . . . ,N−1.

### By replacing (2) into (3) we may get

$$\begin{matrix}r ( n ) = {\sum }_{k = 0}^{N - 1} c h ( n - k ) \frac{1}{\sqrt{N}} {\sum }_{l = 0}^{N - 1} {s ( l ) [ exp ( \frac{2 π}{N} j ) ]}^{lk} \\ = {\sum }_{k = 0}^{N - 1} s ( l ) \frac{1}{\sqrt{N}} {\sum }_{k = 0}^{N - 1} c {h ( n - k ) [ exp ( \frac{2 π}{N} j ) ]}^{lk}\end{matrix} \qquad ( 4 )$$

### We further denote

$$F ( n , l ) = \frac{1}{\sqrt{N}} {\sum }_{k = 0}^{N - 1} c {h ( n - k ) [ exp ( \frac{2 π}{N} j ) ]}^{lk} ,$$

then the received data can be further expressed as

$$[ \begin{matrix}r ( 0 ) \\ r ( 1 ) \\ ⋮ \\ r ( N - 1 )\end{matrix} ] = ( \begin{matrix}F ( 0 , 0 ) & F ( 0 , 1 ) & ⋯ & F ( 0 , N - 1 ) \\ F ( 1 , 0 ) & F ( 1 , 1 ) & ⋯ & F ( 1 , N - 1 ) \\ ⋯ & ⋯ & ⋯ & ⋯ \\ F ( N - 1 , 0 ) & F ( N - 1 , 1 ) & ⋯ & F ( N - 1 , N - 1 )\end{matrix} ) [ \begin{matrix}s ( 0 ) \\ s ( 1 ) \\ ⋮ \\ s ( N - 1 )\end{matrix} ] + noise \qquad ( 5 )$$

It can be seen that each row of the coefficient matrix in the above equation is the IFFT output of the multipath channel either in original order or its cyclically shifted version. Because the multipath channel always has a finite number of taps, there exist many efficient algorithms for its IFFT computation.

The equation (5) has N equations and less than N unknowns (some of variables s(i), i=0, 1, . . . , N−1, bound to be zeros such as the first few and the last few). Therefore the equations can be either resolved by least mean square (LMS) method, maximum likelihood method (MLD) or LU decomposition method.

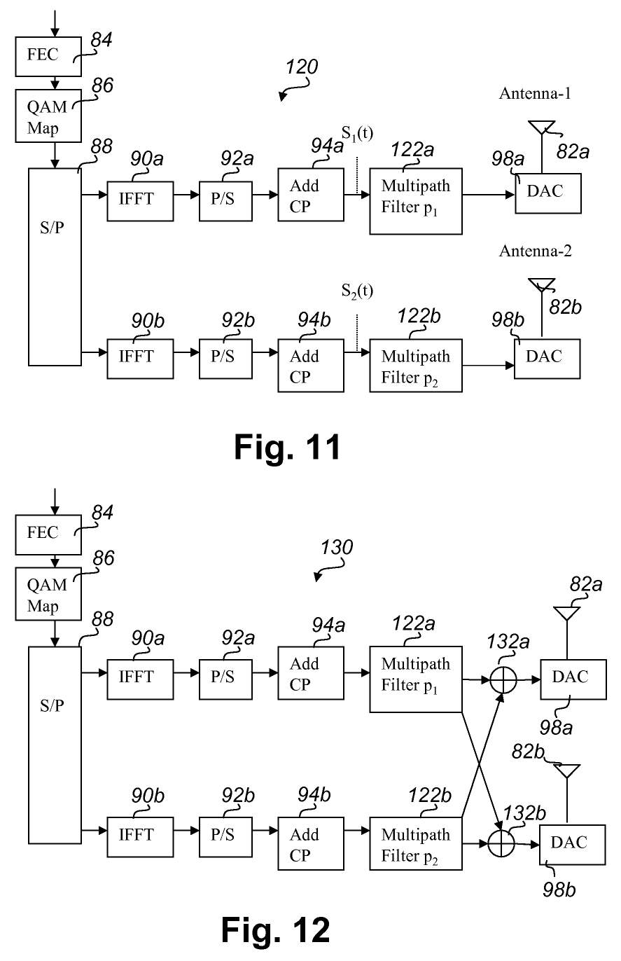

Traditional communication systems typically transmit a pure information signal. Referring to FIG. 11, there is illustrated a OFDM transmitter with two antennas in accordance with a second embodiment of the present invention. The embodiment 120 of FIG. 11 creates a preferred multi-path signal before transmission. The multi-path effect is pre-defined so that the environment intervenes when the signal propagates. Each antenna 82a and 82b is matched with one FIR (finite impulse response) multipath filter 122a and 122b that satisfies some optimal criteria. For two antennas 82 for example, the two multi-path filers 122 are defined as:

$$\begin{matrix}{p}_{1} ( t ) = {\sum }_{k = 1}^{P} {a}_{k} rect ( t - {t}_{k} ) & ( 6 ) \\ {p}_{2} ( t ) = {\sum }_{k = 1}^{P} {b}_{k} rect ( t - {d}_{k} ) & ( 7 )\end{matrix}$$

where rect(t) represents the rectangular pulse and aₖ, tₖ, bₖ, dₖ are pre-designed parameters. Preferably the delay parameters tₖ, dₖ are aligned with sampling rate. Preferably the filters p₁(t) and p₂(t) satisfy the digitized vector pairs:

$$Γ ( j ) = \{ {p}_{1} ( ( m + \frac{j}{J} ) T ) \vert m = 0 , 1 , … , L \} and$$

$$Φ ( j ) = \{ {p}_{2} ( ( m + \frac{j}{J} ) T ) \vert m = 0 , 1 , … , L \}$$

where j runs from 0 to J−1, satisfy the following conditions.

### Optimality Criterions for Transmit:

### Let Xⱼ=[Xⱼ(0),Xⱼ(1), . . . ,Xⱼ(N−1)=FFT(Γ(j)) and

### Yⱼ=[Yⱼ(0),Yⱼ(1), . . . ,Yⱼ(N−1)=FFT(Φ(j)), i, k=0, 1, . . . , J−1. Then there exist integers i, k such that the matrices

$$Ψ ( n ) = ( \begin{matrix}{X}_{i} ( n ) & {Y}_{i} ( n ) \\ {X}_{k} ( n ) & {Y}_{k} ( n )\end{matrix} ) , 0 \leq {N}_{1} \leq n \leq {N}_{2} \leq M - 1 ,$$

are good conditioned. In other word, the two eigen values λ₁(n) and λ₂(n) of matrix Ψ(n)*Ψ(n) are relatively proportional.

Referring to FIG. 12, there is illustrated a OFDM transmitter 130 with two antennas in accordance with a third embodiment of the present invention. Similar to embodiment of FIG. 12, each signal from the multipath filters 122a and 122b are applied to both antennas using adders 132a and 132b

### The received signal for FIG. 12 is

$$\begin{matrix}r ( t ) = {s}_{1} ( t ) ⊗ [ {p}_{1} ( t ) ⊗ c {h}_{11} ( t ) ] + {s}_{2} ( t ) ⊗ [ {p}_{2} ( t ) ⊗ c {h}_{11} ( t ) ] + \\ {s}_{1} ( t ) ⊗ [ {p}_{1} ( t ) ⊗ c {h}_{21} ( t ) ] + {s}_{2} ( t ) ⊗ [ {p}_{2} ( t ) ⊗ c {h}_{21} ( t ) ] + n ( t ) \\ = {s}_{1} ( t ) ⊗ [ {p}_{1} ( t ) ⊗ ( c {h}_{11} ( t ) + c {h}_{21} ( t ) ) ] + {s}_{2} ( t ) ⊗ [ {p}_{2} ( t ) ⊗ \\ ( c {h}_{11} ( t ) + c {h}_{21} ( t ) ) ] + n ( t )\end{matrix}$$

Effectively, the independent data streams s₁(t) and s₂(t) experience more multipath selection process and therefore more diversity can be expected. The receiver implementation is the same as shown in FIG. 10.

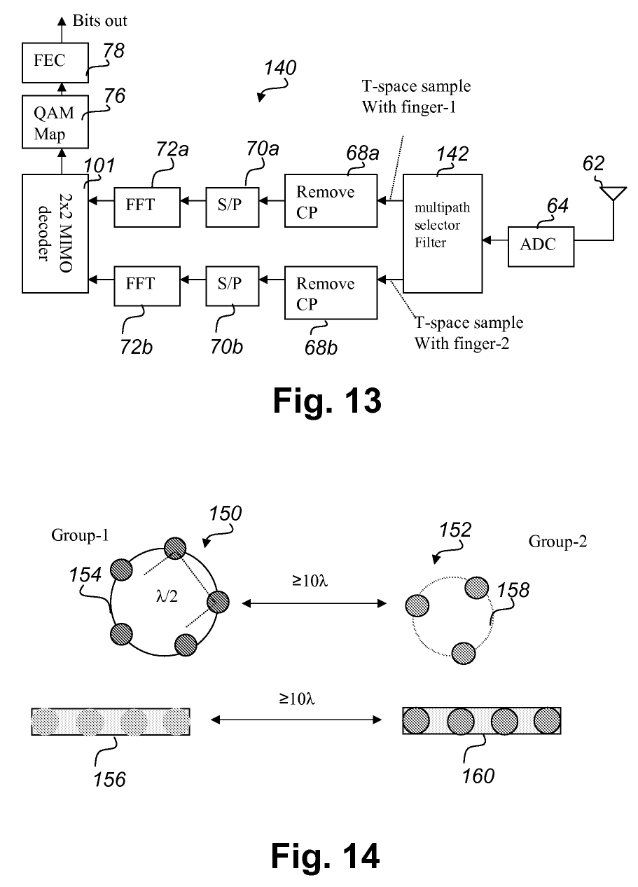

Referring to FIG. 13, there is illustrated a OFDM MIMO receiver in accordance with a fourth embodiment of the present invention of the present invention. Traditional MIMO usually assumes that the number of receiver antennas is no less than the number of transmitter antennas. In embodiment 140 of FIG. 13, we show how to use one antenna to decode signals from two or multiple transmitter antennas as exemplified in the embodiment of FIG. 11.

Suppose the received signal is r(t), ch11(t) and ch21(t) represent the multipath channels from antenna-1 to receiver-1 and antenna-2 to receiver-1 respectively. According to the transmission scheme illustrated in FIG. 11, r(t) can be expressed as:

r(t)=s₁(t)⊕[p₁(t)⊕ch₁₁(t)]+s₂(t)⊕[p₂(t)⊕ch₂₁(t)]+n(t) (8)

### After ADC, the r(t) is digitized as

$$r ( m T + \frac{j}{J} T ) = \{ {s}_{1} ( ( m + \frac{j}{J} ) T ) \} ⊗ [ C {H}_{11} ( ( m + \frac{j}{J} ) T ) \} + \{ {s}_{2} ( ( m + \frac{j}{J} ) T ) \} ⊗ \{ C {H}_{21} ( ( m + \frac{j}{J} ) T ) \} + n ( ( m + \frac{j}{J} ) T ) \qquad ( 9 )$$

where CH₁₁(t)=p₁(t)⊕ch₁₁(t) and CH₂₁(t)=p₂(t)⊕ch₂₁(t). A multipath selector 142 uses either a training sequence or a preamble to identify those time stamps or fingers embedded in the received signal. The outputs of multipath selector 142 is the integer indices i, k, 1 etc. The receiver selects two indices (for two antenna case), say i, k so that the chosen multipath profiles satisfy the following optimality conditions.

### Optimality Criterions for Receive:

### Define

$$Θ ( i ) = \{ C {H}_{11} ( ( m + \frac{i}{J} ) T ) \vert m = 0 , 1 , … , L \} and$$

$$Ω ( k ) = \{ C {H}_{21} ( ( m + \frac{j}{J} ) T ) \vert m = 0 , 1 , … , L \}$$

### Let Xᵢ=[Xᵢ(0),Xᵢ(1), . . . , (Xᵢ(N−1)=FFT(Θ(i)) and

### Yₖ=[Yₖ(0),Yₖ(1), . . . ,Yₖ(N−1)=FFT(Ω(k)) and i, k=0, 1, . . . , J−1

$$Ψ ( n ) = ( \begin{matrix}{X}_{i} ( n ) & {Y}_{i} ( n ) \\ {X}_{k} ( n ) & {Y}_{k} ( n )\end{matrix} ) , 0 \leq {N}_{1} \leq n \leq {N}_{2} \leq M - 1 ,$$

are in good condition or a group of them are good conditioned. In other words, the two eigen values λ₁(n) and λ₂(n) of matrix Ψ(n)*Ψ(n) are well balanced for a group of n and n is the subcarrier index. Note that different sub-carriers may correspond to different (i, k) pair to meet optimality conditions.

The receiver of FIG. 13, can also be used for OFDM MIMO in accordance with a fifth embodiment of the present invention, as only one antenna is needed to decode a two or multiple antennas parallel transmission. After ADC, a multi-path selector 142 chooses at least two multipath profiles. A filtering process associated with each finger down converts the sampling rate back to Nyquist sampling rate (T-spaced) and then the normal decoding process can be applied. In frequency domain (after FFT), the received data can be expressed as

$$[ \begin{matrix}{Z}_{1} ( n ) \\ {Z}_{2} ( n )\end{matrix} ] = ( \begin{matrix}{X}_{i} ( n ) & {Y}_{i} ( n ) \\ {X}_{k} ( n ) & {Y}_{k} ( n )\end{matrix} ) [ \begin{matrix}{s}_{1} ( n ) \\ {s}_{2} ( n )\end{matrix} ] + [ \begin{matrix}{n}_{1} \\ {n}_{2}\end{matrix} ] \qquad ( 10 )$$

where s₁(n) and s₂(n) are unknowns that need to be determined.

Beam-formed MIMO. Referring to FIG. 14 there is illustrated beam-forming MIMO configurations in accordance with a sixth embodiment of the present invention. In traditional beam-forming antenna arrays, the inter-element distance is required to be not more than half wavelength space. In accordance with the embodiment of FIG. 14, quite different the antenna arrays are possible, for example antennas can be grouped into multiple groups and within each group, the inter-element space is not more than half of the wavelength. But inter-group distance can be arbitrary. Two examples of these configurations have been illustrated in FIG. 13 where each configuration 150 and 152 has only two beam-former antenna array groups 154 and 156 and 158 and 160, respectively.

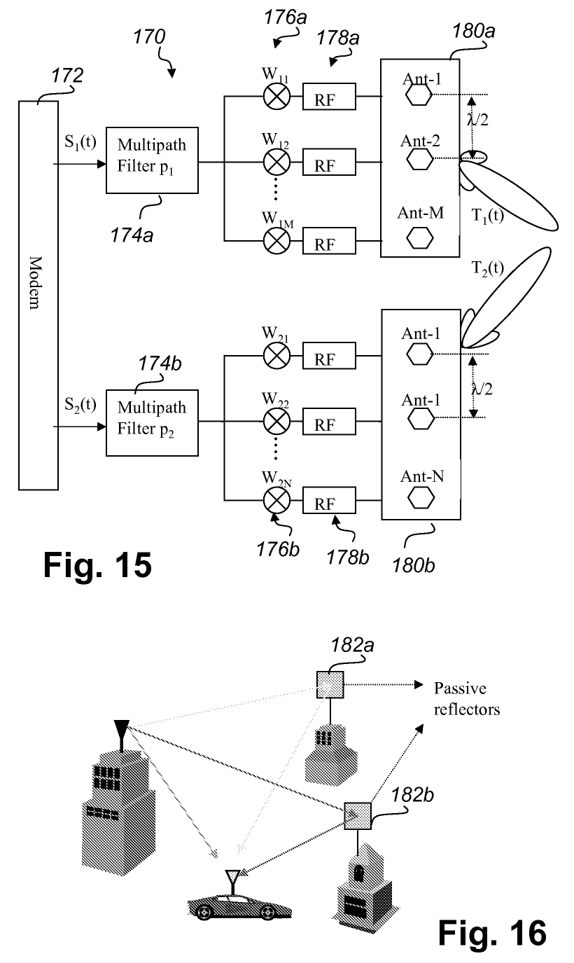

Referring to FIG. 15, there is illustrated a beam-formed MIMO transmitter 170 with built in multipath in accordance with a seventh embodiment of the present invention. Quite different from traditional beam-former shown in FIG. 4, each signal S₁(t) and S₂(t) is filtered by a predefined multi-path filter 174a and 174b, respectively, before beam-forming. The purpose of predefined filters to create multipath in the base-band so that MIMO transmission can be fulfilled even in line of sight scenarios.

$${T}_{1} ( t ) = {\sum }_{m = 1}^{M} {w}_{1 m} {s}_{1} ( t ) ⊗ {p}_{1} ( t ) and {T}_{2} ( t ) = {\sum }_{n = 1}^{N} {w}_{2 n} {s}_{2} ( t ) ⊗ {p}_{2} ( t )$$

The receiver model for the antenna of FIG. 14 and transmitter of FIG. 15 is the same as that of FIG. 13 except that the transmitter antenna are a more sophisticated design so that the beam pattern is much narrower and pointing to the desired direction. Here we treat a group of antennas transmitting the same signal as one big umbrella antenna for MIMO system.

Because the system is a MIMO system, it needs a multipath environment. For those knowing the art and working in the testing equipment market, it is easy to implement a feature so that the equipment can test MIMO terminal or BTS in the lab environment without using complicated equipment or a real multipath environment.

Referring to FIG. 16 there is illustrated passive reflectors used to introduce multipath in accordance with a eight embodiment of the present invention. Thus an alternative way to create multi-path is to install passive reflectors 182a and 182b surrounding the transmitter rather than using multipath filters within the transmitter itself.

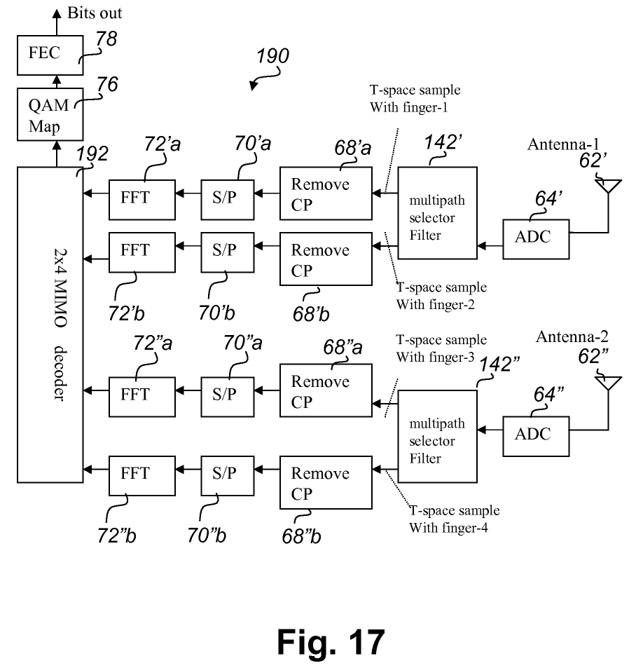

In the above embodiments, we are mainly focusing on one receive antenna, however, it is straightforward to apply the above teachings to generic multiple transmit and multiple receive antennas systems. An example of such a receiver 190 is shown in FIG. 17 in accordance with a ninth embodiment of the present invention.

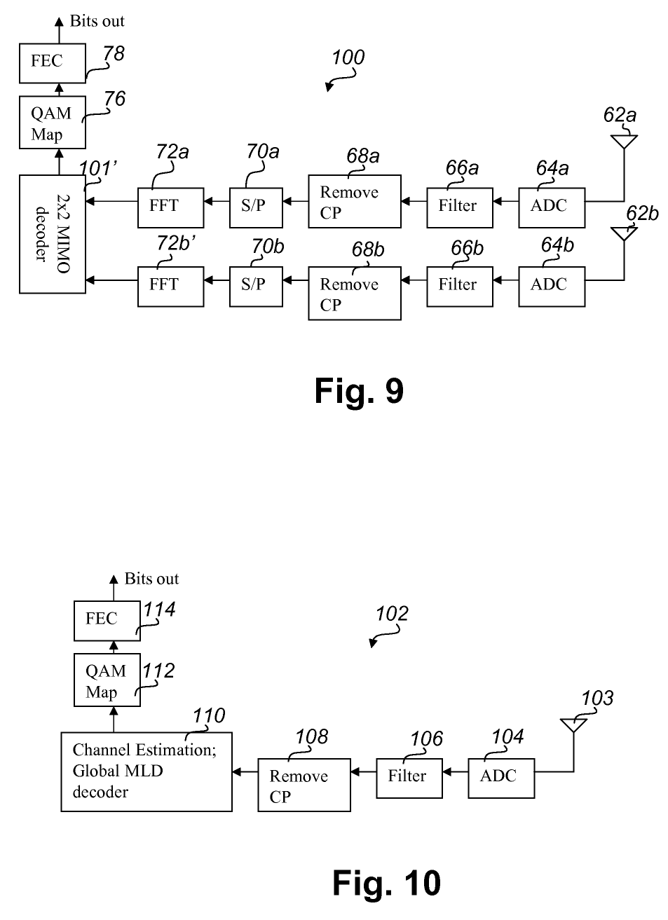

As each single receive antenna can be functionally used as two or more antennas (refer equation (10) as well), the multiple receive antennas system performance can be significantly enhanced without having to add more hardware. For two receiver antennas for example (refer to FIG. 9), the receiver can be implemented so that the performance is similar to that of four receiver antennas, as shown in FIG. 17. According to equation (10), each antenna can build more than two mathematical equations with two unknowns. Therefore two receiving antennas 62′ and 62″ can build more than four equations so the MIMO decoder 192 can be structured as two transmits and four receives so as the performance. After FFT and channel estimations, we can steadily derive the following equations and each pair comes from one antenna.

$$\begin{matrix}[ \begin{matrix}{Z}_{1} ( n ) \\ {Z}_{2} ( n )\end{matrix} ] = ( \begin{matrix}{X}_{i} ( n ) & {Y}_{i} ( n ) \\ {X}_{k} ( n ) & {Y}_{k} ( n )\end{matrix} ) [ \begin{matrix}{s}_{1} ( n ) \\ {s}_{2} ( n )\end{matrix} ] + [ \begin{matrix}{n}_{1} \\ {n}_{2}\end{matrix} ] & ( 11 ) \\ [ \begin{matrix}{Z}_{3} ( n ) \\ {Z}_{4} ( n )\end{matrix} ] = ( \begin{matrix}{X}_{j} ( n ) & {Y}_{j} ( n ) \\ {X}_{l} ( n ) & {Y}_{l} ( n )\end{matrix} ) [ \begin{matrix}{s}_{1} ( n ) \\ {s}_{2} ( n )\end{matrix} ] + [ \begin{matrix}{n}_{3} \\ {n}_{4}\end{matrix} ] & ( 12 )\end{matrix}$$

Now we have built four equations with two unknowns that can be resolved by directly or by using maximum likelihood methods.

The present example of FIG. 17 shows two receiving antennas. It can be extended to any number of antennas with any number of equations built from one antenna.

In accordance with a tenth embodiment, each receiving antenna can be replaced by a beam receiving antenna array, which output a received beam. The receiver implementation is the same as FIG. 17 except the input to each multipath selector and filter box comes from a beam-former antenna array.

### REFERENCES

[1] IEEE STD 802.16-2004
[2] IEEE STD 802.16e-2005.

Numerous modifications, variations and adaptations may be made to the particular embodiments described above without departing from the scope patent disclosure, which is defined in the claims.

What is claimed is:

1. A wireless data communications system for comprising:
means for effecting multipath onto a signal;
means for receiving the signal; and
means for decoding the signal in dependence upon the multipath effected.

2. A system as claimed in claim 1, wherein the means for effecting multipath includes a multipath filter within a transmitter.

3. A system as claimed in claim 2, wherein the effecting multipath filter is satisfying Optimality Criterions for Transmit, defined by:
Let Xⱼ=[Xⱼ(0),Xⱼ(1), . . . ,Xⱼ(N−1)=FFT(Γ(j)) and
Yⱼ=[Yⱼ(0),Yⱼ(1), . . . ,Yⱼ(N−1)=FFT((Φ(j)), i, k=0, 1, . . . , J−1 then there exist integers i, k such that the matrices
$$Ψ ( n ) = ( \begin{matrix}{X}_{i} ( n ) & {Y}_{i} ( n ) \\ {X}_{k} ( n ) & {Y}_{k} ( n )\end{matrix} ) , 0 \leq {N}_{1} \leq n \leq {N}_{2} \leq M - 1 ,$$
are good conditioned. In other word, the two eigen values λ₁(n) and λ₂(n) of matrix Ψ(n)*Ψ(n) are relatively proportional.

4. A system as claimed in claim 1, wherein the means for effecting multipath includes a plurality of multipath filters within a transmitter coupled to a corresponding plurality of antennas.

5. A system as claimed in claim 3, wherein each multipath filter includes a plurality of outputs.

6. A system as claimed in claim 4, wherein the plurality of outputs corresponds to the plurality of antennas

7. A system as claimed in claim 1, wherein the means for effecting multipath includes a plurality of multipath filters within a transmitter coupled to a corresponding plurality of antenna arrays.

8. A system as claimed in claim 6, wherein the antenna arrays comprise beam forming antennas.

9. A system as claimed in claim 1 wherein the signal is an orthogonal frequency division multiplexed (OFDM) signal.

10. A system as claimed in claim 8 wherein the receiver decoder uses the following equation
$$[ \begin{matrix}r ( 0 ) \\ r ( 1 ) \\ ⋮ \\ r ( N - 1 )\end{matrix} ] = ( \begin{matrix}F ( 0 , 0 ) & F ( 0 , 1 ) & ⋯ & F ( 0 , N - 1 ) \\ F ( 1 , 0 ) & F ( 1 , 1 ) & ⋯ & F ( 1 , N - 1 ) \\ ⋯ & ⋯ & ⋯ & ⋯ \\ F ( N - 1 , 0 ) & F ( N - 1 , 1 ) & ⋯ & F ( N - 1 , N - 1 )\end{matrix} ) [ \begin{matrix}s ( 0 ) \\ s ( 1 ) \\ ⋮ \\ s ( N - 1 )\end{matrix} ] + noise$$

11. A system as claimed in claim 1 wherein the system is a multiple input multiple output (MIMO) system.

12. A system as claimed in claim 9 wherein the signal is an orthogonal frequency division multiplexed (OFDM) signal.

13. A system as claimed in claim 1, wherein the means for effecting multipath includes a plurality of reflectors in spaced relationship from a transmitter for transmitting the signal.

14. A system as claimed in claim 11, wherein the transmitter is coupled to a plurality of antennas.

15. A system as claimed in claim 11, wherein the plurality of antennas include antenna arrays.

16. A system as claimed in claim 13, wherein the antenna arrays comprise beam forming antennas.

17. A system as claimed in claim 11 wherein the signal is an orthogonal frequency division multiplexed (OFDM) signal.

18. A system as claimed in claim 11 wherein the system is a multiple input multiple output (MIMO) system.

19. A system as claimed in claim 16 wherein the signal is an orthogonal frequency division multiplexed (OFDM) signal.

20. A system as claimed in claim 1, wherein the means for decoding the signal includes a channel estimation equalizer.

21. A system as claimed in claim 1, wherein the means for decoding the signal includes a multipath selector filter.

22. A system as claimed in claim 19, wherein the multipath selector filter includes two MIMO output channels.

23. A system as claimed in claim 19, wherein the multipath selector filter will select the outputs according to Optimality Criterions for Receive, defined by
$$Θ ( i ) = \{ C {H}_{11} ( ( m + \frac{i}{J} ) T ) \vert m = 0 , 1 , … , L \} and$$
$$Ω ( k ) = \{ C {H}_{21} ( ( m + \frac{j}{J} ) T ) \vert m = 0 , 1 , … , L \}$$
Let Xᵢ=[Xᵢ(0), Xᵢ(1), . . . ,Xᵢ(N−1)=FFT(Θ(i)) and
Yₖ=[Yₖ(0),Yₖ(1), . . . , Yₖ(N−1)=FFT(Ω(k)) and i, k=0, 1, . . . , J−1
$$Ψ ( n ) = ( \begin{matrix}{X}_{i} ( n ) & {Y}_{i} ( n ) \\ {X}_{k} ( n ) & {Y}_{k} ( n )\end{matrix} ) , 0 \leq {N}_{1} \leq n \leq {N}_{2} \leq M - 1 ,$$
are in good condition or a group of them are good conditioned, that is, the two eigen values λ₁(n) and λ₂(n) of matrix Ψ(n)*Ψ(n) are well balanced for a group of n and n is the subcarrier index.

24. A system as claimed in claim 21, wherein the multipath selector filter includes multiple MIMO output channels.

25. A system as claimed in claim 19, wherein the multipath selector filter includes multiple MIMO output channels.

26. A system as claimed in claim 22, wherein only one receiver antenna to receive multiple independent parallel transmissions

27. A method of comprising:
effecting multipath onto a signal;
receiving the signal; and
decoding the signal in dependence upon the multipath effected.

28. A method of claim 21, wherein the step of effecting multipath is prior to transmitting the signal from a transmitter.

29. A method of claim 21, wherein the step of effecting multipath is after transmitting the signal from a transmitter.
